(19) United States
(12) Patent Application Publication
(10) Pub. No.: US 2014/0055342 A1
(43) Pub. Date: Feb. 27, 2014

(54) GAZE DETECTION APPARATUS AND GAZE DETECTION METHOD

(71) Applicant: FUJITSU LIMITED, Kawasaki-shi (JP)

(72) Inventors: Takuya KAMIMURA, Kobe (JP); Hiroyasu YOSHIKAWA, Akashi (JP)

(21) Appl. No.: 13/909,452

(22) Filed: Jun. 4, 2013

(30) Foreign Application Priority Data
Aug. 21, 2012 (JP) 2012-182720

(51) Int. Cl. G06F 3/01

(52) U.S. Cl. CPC G06F 3/013
USPC 345/156

(57) ABSTRACT

A gaze detection apparatus includes: a first imaging unit which has a first angle of view and generates a first image; a second imaging unit which has a second angle of view narrower than the first angle of view, and generates a second image; a face detection unit which detects from the first image a face region; a coordinate conversion unit which identifies on the second image a first region corresponding to the face region or to an eye peripheral region containing the user's eye; a Purkinje image detection unit which detects a corneal reflection image of a light source and the center of the user's pupil from within an eye region, identified based on the first region; and a gaze detection unit which detects the user's gaze direction or gaze position based on a positional relationship between the center of the pupil and the corneal reflection image.

### CROSS-REFERENCE TO RELATED APPLICATION

This application is based upon and claims the benefit of priority of the prior Japanese Patent Application No. 2012-182720, filed on Aug. 21, 2012, the entire contents of which are incorporated herein by reference.

### FIELD

The embodiments discussed herein are related to a gaze detection apparatus and gaze detection method for detecting a gaze direction by detecting a Purkinje image.

### BACKGROUND

In the prior art, techniques have been proposed for detecting the position on a display at which a user is gazing by using a detector and a light source disposed around the display (for example, refer to International Patent Publication No. 2004/045399 and Japanese Laid-open Patent Publication No. 2011-115606).

According to such techniques, in order to accurately detect the position at which the user is gazing, an image of the user's eye captured by the detector is analyzed to detect a corneal reflection image of the light source and the user's pupil and to obtain the displacement between the position of its Purkinje image and the position of the pupil. Then, the gaze position is determined by referring, for example, to a table that translates the displacement between the position of the corneal reflection image and the position of the pupil into the gaze position. The corneal reflection image of the light source is referred to as the Purkinje or Purkyne image. In the present application, the corneal reflection image of the light source will be referred to as the Purkinje image.

Since the positional relationship between the display and the user's head is not fixed, it is preferable to use a wide-angle camera to capture an image of the user's eyes so that the user's eyes will be contained in the captured image. On the other hand, the above technique requires that the size of the eye in the captured image be large enough that the pupil and the Purkinje image can be recognized in the captured image. However, since the size of the eye in the image captured by a wide-angle camera tends to be small, there has been the problem that it is difficult to detect the pupil and the Purkinje image from the image captured by the wide-angle camera. Furthermore, in such an image, there has been the possibility that the amount of change in the distance between the pupil and the Purkinje image on the captured image that corresponds to the smallest amount of movement of the user's gaze position to the detected (corresponding, for example, to the distance between two adjacent icons displayed on the display) may become smaller than one pixel. There has therefore been the problem that the change in the gaze position may not be able to be detected even if the pupil and the Purkinje image have been detected successfully.

On the other hand, there is proposed a technique that, based on a wide-angle image of a subject captured by a first imaging device, controls the orientation of a second imaging device for capturing an image of the subject's eyeball, and that computes gaze position information from the image captured by the second imaging device (for example, refer to Japanese Laid-open Patent Publication No. 2005-323905).

However, with the technique disclosed in Japanese Laid-open Patent Publication No. 2005-323905, since the orientation of the camera used to detect the user's gaze is changed after determining the position of the eyeball, and thereafter the gaze is detected from the image captured by that camera, a delay occurs until the gaze can be detected. Furthermore, since the technique requires the provision of a mechanism for changing the orientation of the camera used to detect the user's gaze, the cost of the apparatus that uses this technique increases.

### SUMMARY

According to one embodiment, a gaze detection apparatus is provided. The gaze detection apparatus includes: a light source which illuminates a user's eye; a first imaging unit which has a first angle of view and generates a first image by capturing an image of the user's face; a second imaging unit which has a second angle of view narrower than the first angle of view generates a second image by capturing an image of at least a portion of the user's face; a face detection unit which detects from the first image a face region containing the user's face; a coordinate conversion unit which identifies on the second image a first region that corresponds to the face region or to an eye peripheral region detected from within the face region as containing the user's eye; a Purkinje image detection unit which detects a corneal reflection image of the light source and the center of the user's pupil from within an eye region, identified based on the first region, that contains the user's eye on the second image; and a gaze detection unit which detects the user's gaze direction or gaze position based on a positional relationship between the center of the pupil and the corneal reflection image.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating the hardware configuration of a computer implementing one embodiment of a gaze detection apparatus.

FIG. 2 is a schematic front view of a display unit.

FIG. 3 is a functional block diagram of a control unit for implementing a gaze detection process.

FIG. 4 is a diagram illustrating the relationship of the field of view of a wide-angle camera relative to the field of view of an infrared camera when observed from a position located a prescribed distance away from a display screen of a display unit.

FIG. 5 is a diagram illustrating one example of a mapping table.

FIG. 6 is a diagram illustrating one example of a gaze position table.

FIG. 7 is an operation flowchart of the gaze detection process.

FIG. 8 is a functional block diagram of a control unit for implementing a gaze detection process in a gaze detection apparatus according to a second embodiment.

FIG. 9A is a diagram illustrating one example of the relative position of an enlarged eye peripheral region with respect to a narrow-angle image.

FIG. 9B is a diagram illustrating another example of the relative position of an enlarged eye peripheral region with respect to a narrow-angle image.

FIG. 10 is an operation flowchart illustrating the steps relating to the operation of an eye precision detection unit in the gaze detection process carried out by the gaze detection apparatus according to the second embodiment.

FIG. 11 is a functional block diagram of a control unit for implementing a gaze detection process in a gaze detection apparatus according to a third embodiment.

### DESCRIPTION OF EMBODIMENTS

A gaze detection apparatus according to one embodiment will be described below with reference to drawings.

The gaze detection apparatus includes a first camera having an angle of view capable of capturing an image of the whole face of a user as long as the user's face is located within a preassumed range, and a second camera having an angle of view narrower than the angle of view of the first camera and capable of capturing an image of a size such that a pupil and a Purkinje image can be recognized in the captured image. The gaze detection apparatus detects the position of the user's face or the position of the user's eye from the first image captured by the first camera. Then, using information representing the face position or the eye position, the gaze detection apparatus restricts the range within which to detect the pupil and the Purkinje image on the second image captured by the second camera, and thereby enhances the accuracy with which the pupil and the Purkinje image can be detected.

In the embodiment hereinafter described, the gaze detection apparatus is incorporated into a computer, and detects the position on a computer display at which the user is gazing. However, the gaze detection apparatus can be applied to various other apparatus, such as portable information terminals, mobile telephones, car driving assisting apparatus, or car navigation systems, that detect the user's gaze position or gaze direction and that use the detected gaze position or gaze direction.

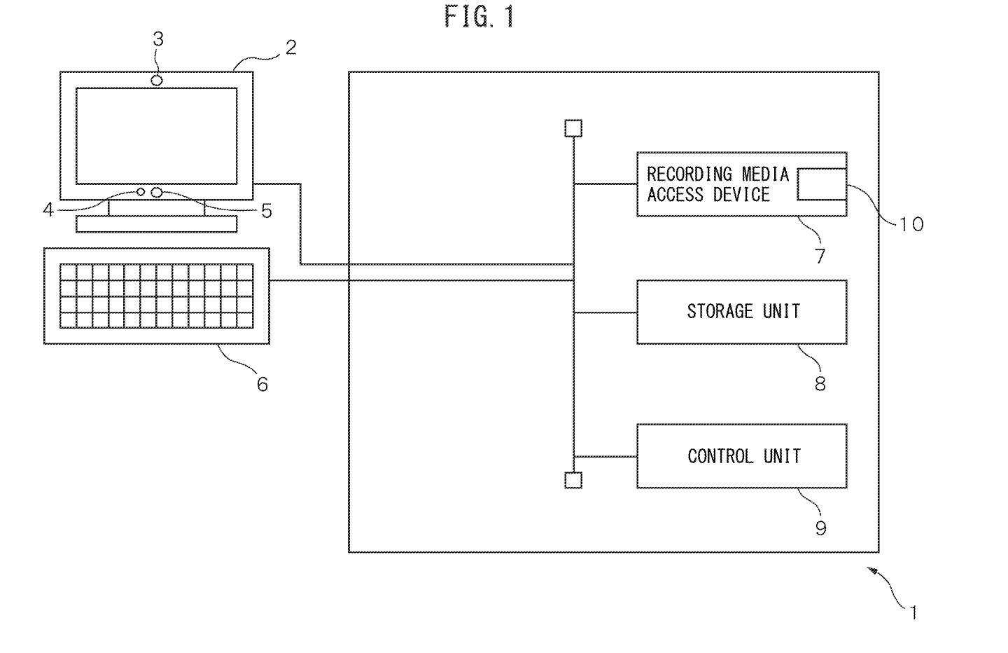

FIG. 1 is a diagram illustrating the hardware configuration of a computer implementing one embodiment of the gaze detection apparatus. The computer 1 includes a display unit 2, a wide-angle camera 3, an illuminating light source 4, an infrared camera 5, an input unit 6, a storage media access device 7, a storage unit 8, and a control unit 9. The computer 1 may further include a communication interface circuit (not depicted) for connecting the computer 1 to other apparatus. The computer 1 may be a so-called desktop computer. In this case, of the various component elements constituting the computer 1, the storage media access device 7, the storage unit 8, and the control unit 9 are contained in a cabinet (not depicted); on the other hand, the display unit 2, the wide-angle camera 3, the illuminating light source 4, the infrared camera 5, and the input unit 6 are provided separately from the cabinet. Alternatively, the computer 1 may be a notebook computer. In this case, all of the component elements constituting the computer 1 may be contained in a single cabinet. Further alternatively, the computer 1 may be a computer integrated with a display, in which case all of the component elements, except for the input unit 6, are contained in a single cabinet.

The display unit 2 includes, for example, a liquid crystal display or an organic electroluminescent display. The display unit 2 displays, for example, various icons or operation menus in accordance with control signals from the control unit 9. Each icon or operation menu is associated with information indicating a position or range on the display screen of the display unit 2. As a result, when the user's gaze position detected by the control unit 9 is located at a specific icon or operation menu, it can be determined that the specific icon or operation menu has been selected, as will be described later.

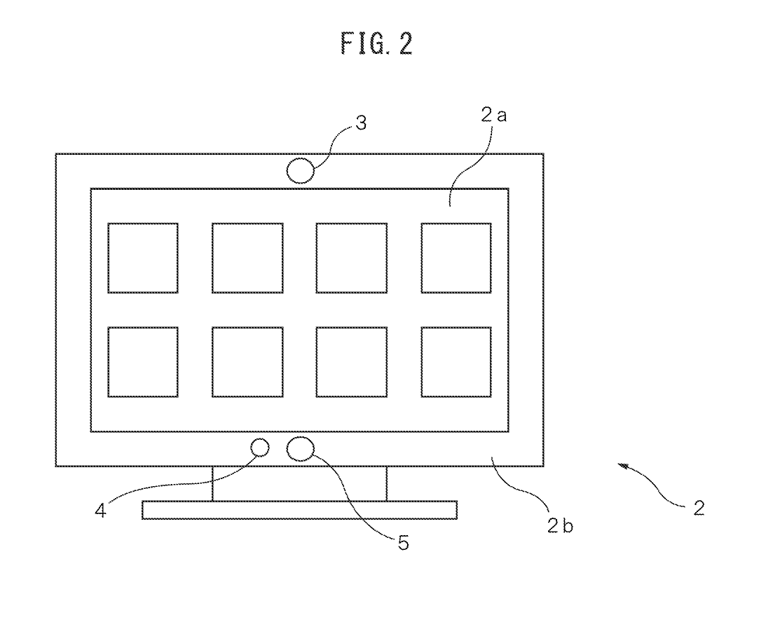

FIG. 2 is a schematic front view of the display unit 2. The display screen 2a for displaying various icons, etc., is provided in the center of the display unit 2, and the display screen 2a is held in position by a surrounding frame 2b. The wide-angle camera 3 is mounted approximately in the center of the frame 2b above the display screen 2a. The illuminating light source 4 and the infrared camera 5 are mounted side by side approximately in the center of the frame 2b below the display screen 2a. In the present embodiment, the wide-angle camera 3 and the infrared camera 5 are mounted by aligning the horizontal position of the wide-angle camera 3 with respect to the horizontal position of the infrared camera 5.

It is preferable that the wide-angle camera 3 is mounted with its optical axis oriented at right angles to the display screen 2a so that the whole face of the user gazing at the display screen 2a will be contained in the captured image. On the other hand, it is preferable that the infrared camera 5 is mounted with its optical axis oriented either at right angles to the display screen 2a or upward from the normal to the display screen 2a so that the user's eyes and their surrounding portions will be contained in the image captured by the infrared camera 5.

The wide-angle camera 3 is one example of the first imaging unit, has sensitivity to visible light, and has an angle of view (for example, a diagonal angle of view of 60 to 80 degrees) capable of capturing an image of the whole face of the user as long as the face of the user gazing at the display unit 2 of the computer 1 is located within a preassumed range. Then, during the execution of the gaze detection process, the wide-angle camera 3 generates images containing the whole face of the user by shooting, at a predetermined frame rate, the face of the user facing the display screen 2a. Each time the face-containing image is generated, the wide-angle camera 3 passes the image to the control unit 9. Like the infrared camera 5, the wide-angle camera 3 also may be a camera having sensitivity to the infrared light radiated from the illuminating light source 4.

The illuminating light source 4 includes an infrared light emitting source constructed, for example, from at least one infrared emitting diode, and a driving circuit that supplies power from a power supply (not depicted) to the infrared emitting diode in accordance with a control signal received from the control unit 9. The illuminating light source 4 is mounted in the frame 2b side by side with the infrared camera 5 so that the face of the user gazing at the display screen 2a, in particular, the eyes of the user, can be illuminated. The illuminating light source 4 continues to emit the illuminating light during the period when the control signal for lighting the light source is being received from the control unit 9.

The number of infrared emitting diodes constituting the illuminating light source 4 is not limited to one, but the illuminating light source 4 may be constructed using a plurality of infrared emitting diodes disposed at different positions. For example, the illuminating light source 4 may include two infrared emitting diodes, and each infrared emitting diode may be mounted in the frame 2b of the display unit 2 in such a manner that the infrared camera 5 is located between the two infrared emitting diodes.

The infrared camera 5 is one example of the second imaging unit, and generates an image containing at least a portion of the user's face including the eyes. For this purpose, the infrared camera 5 includes an image sensor constructed from a two-dimensional array of solid-state imaging devices having sensitivity to the infrared light radiated from the illuminating light source 4, and an imaging optic for focusing an image of the user's eye onto the image sensor. The infrared camera 5 may further include a visible-light cutoff filter between the image sensor and the imaging optic in order to prevent an image reflected by the iris and a Purkinje image of any light other than the illuminating light source 4 from being detected.

The infrared camera 5 has an angle of view (for example, a diagonal angle of view of 30 to 40 degrees) narrower than the angle of view of the wide-angle camera 3. Then, during the execution of the gaze detection process, the infrared camera 5 generates images containing the user's eyes by shooting the user's eyes at a predetermined frame rate. The infrared camera 5 has a resolution high enough that the pupil and the Purkinje image of the light source 4 reflected on the user's cornea can be recognized in the generated image. Each time the eye-containing image is generated, the infrared camera 5 passes the image to the control unit 9.

Since the infrared camera 5 is mounted below the display screen 2a of the display unit 2, as earlier described, the infrared camera 5 shoots the face of the user gazing at the display screen 2a from the position below the display screen 2a. As a result, the computer 1 can reduce the chance of the pupil and the Purkinje image being hidden behind the eyelashes when the user's face is imaged by the infrared camera 5.

The sensitivity of the wide-angle camera 3 and the sensitivity of the infrared camera 5 may be optimized independently of each other. For example, the sensitivity of the wide-angle camera 3 may be set relatively low so that the contour of the face can be recognized in the captured image and, on the other hand, the sensitivity of the infrared camera 5 may be set relatively high so that the pupil and the Purkinje image can be recognized in the captured image.

For convenience, the image generated by the wide-angle camera 3 will hereinafter be referred to as the wide-angle image, while the image generated by the infrared camera 5 will be referred to as the narrow-angle image.

The input unit 6 includes, for example, a keyboard and a pointing device such as a mouse. An operation signal entered via the input unit 6 by the user is passed to the control unit 9.

The display unit 2 and the input unit 6 may be combined into one unit such as a touch panel display. In this case, when the user touches an icon displayed at a specific position on the display screen of the display unit 2, the input unit 6 generates an operation signal associated with that position and supplies the operation signal to the control unit 9.

The storage media access device 7 is a device that accesses a storage medium 10 such as a magnetic disk, a semiconductor memory card, or an optical storage medium. The storage media access device 7 accesses the storage medium 10 to read the gaze detection computer program to be executed on the control unit 9, and passes the program to the control unit 9.

The storage unit 8 includes, for example, a readable/writable nonvolatile semiconductor memory and a readable/writable volatile semiconductor memory. The storage unit 8 stores the gaze detection computer program and various application programs to be executed on the control unit 9 and various kinds of data for the execution of the programs. The storage unit 8 also stores information representing the position and range of each icon currently displayed on the display screen of the display unit 2 or the position and range of any operation menu displayed thereon.

The storage unit 8 further stores various kinds of data to be used for the detection of the user's gaze position. For example, the storage unit 8 stores a mapping table that provides a mapping between the position of the center of the pupil relative to the center of the Purkinje image and the gaze direction of the user. The storage unit 8 may also store a coordinate conversion table for translating position coordinates on the wide-angle image into position coordinates on the narrow-angle image.

The control unit 9 includes one or a plurality of processors and their peripheral circuitry. The control unit 9 is connected to each part of the computer 1 by a signal line, and controls the entire operation of the computer 1. For example, the control unit 9 performs processing appropriate to the operation signal received from the input unit 6 and the application program currently being executed.

Further, the control unit 9 carries out the gaze detection process and determines the position on the display screen 2a of the display unit 2 at which the user is gazing. Then, the control unit 9 matches the user's gaze position against the display region, stored in the storage unit 8, of each specific icon or operation menu displayed on the display screen 2a of the display unit 2. When the user's gaze position is located in the display region of any specific icon or operation menu, the control unit 9 performs processing appropriate to the icon or operation menu. Alternatively, the control unit 9 passes information representing the user's gaze position to the application program currently being executed by the control unit 9.

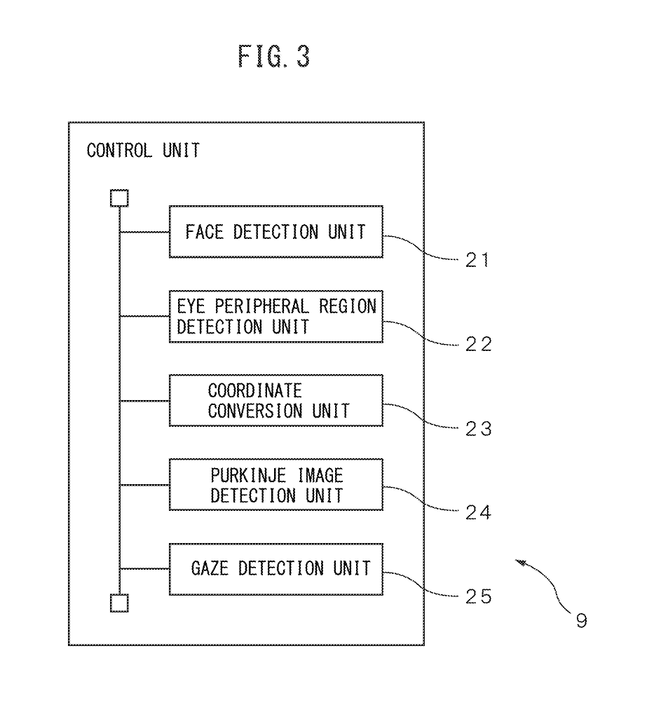

FIG. 3 is a functional block diagram of the control unit 9 for implementing the gaze detection process. The control unit 9 includes a face detection unit 21, an eye peripheral region detection unit 22, a coordinate conversion unit 23, a Purkinje image detection unit 24, and a gaze detection unit 25. These units constituting the control unit 9 are functional modules each implemented by executing a computer program on the processor incorporated in the control unit 9. Alternatively, these units constituting the control unit 9 may be implemented on a single integrated circuit on which the circuits corresponding to the respective units are integrated, and may be mounted in the computer 1 separately from the processor incorporated in the control unit 9. In this case, the integrated circuit may include a storage circuit which functions as a storage unit in the gaze detection apparatus separately from the storage unit 8 and stores various kinds of data used during the execution of the gaze detection process.

The face detection unit 21 detects a face region containing the user's face on the wide-angle image during the execution of the gaze detection process in order to determine the region on the wide-angle image that potentially contains the user's face. For example, the face detection unit 21 converts the value of each pixel in the wide-angle image into a value defined by the HSV color system. Then, the face detection unit 21 extracts any pixel whose hue component (H component) value falls within the range of values corresponding to skin tones (for example, the range of values from 0° to 30°) as a face region candidate pixel that potentially corresponds to a portion of the face.

Further, when the computer 1 is being operated in response to the user's gaze, it can be assumed that the user's face is positioned so as to face the display screen 2a of the display unit 2 and is located several tens of centimeters away from the display screen 2a. As a result, the region that the user's face occupies on the wide-angle image is relatively large, and the size of the region that the face occupies on the wide-angle image can be estimated to a certain extent. Therefore, the face detection unit 21 performs labeling on the face region candidate pixels, and extracts a set of neighboring face region candidate pixels as a face candidate region. Then, the face detection unit 21 determines whether the size of the face candidate region falls within a reference range corresponding to the size of the user's face. If the size of the face candidate region falls within the reference range corresponding to the size of the user's face, the face detection unit 21 determines that the face candidate region is the face region.

The size of the face candidate region is represented, for example, by the number of pixels taken across the maximum horizontal width of the face candidate region. In this case, the size of the reference range is set, for example, not smaller than one-quarter but not larger than two-thirds of the number of pixels in the horizontal direction of the image. Alternatively, the size of the face candidate region may be represented, for example, by the number of pixels contained in the face candidate region. In this case, the size of the reference range is set, for example, not smaller than one-sixteenth but not larger than four-ninths of the total number of pixels contained in the image.

The face detection unit 21 may use not only the size of the face candidate region but also the shape of the face candidate region as the criteria for determining whether the face candidate region is the face region or not. Generally, a human face is elliptical in shape. In view of this, if the size of the face candidate region falls within the above reference range, and if the ellipticity of the face candidate region is not less than a given threshold value corresponding to the contour of a typical face, the face detection unit 21 may determine that the face candidate region is the face region. In this case, the face detection unit 21 can compute the ellipticity by obtaining the total number of pixels located on the contour of the face candidate region as the circumferential length of the face candidate region, multiplying the total number of pixels contained in the face candidate region by 4π, and dividing the result by the square of the circumferential length.

Alternatively, the face detection unit 21 may approximate the face candidate region by an ellipse by substituting the coordinates of each pixel on the contour of the face candidate region into an elliptic equation and by applying a least square method. Then, if the ratio of the major axis to the minor axis of the ellipse falls within a range defining the minimum and maximum of the ratio of the major axis to the minor axis of a typical face, the face detection unit 21 may determine that the face candidate region is the face region. When evaluating the shape of the face candidate region by an elliptic approximation, the face detection unit 21 may detect edge pixels corresponding to edges by calculating differences in brightness between adjacent pixels in the image. In this case, the face detection unit 21 connects the edge pixels by using a technique of labeling, and determines that the edge pixels with a connected length longer than a predetermined length represents the contour of the face candidate region.

Alternatively, the face detection unit 21 may detect the face region by using any one of various other methods for detecting the region of the face contained in the image. For example, the face detection unit 21 may perform template matching between the face candidate region and a template corresponding to the shape of a typical face and compute the degree of matching between the face candidate region and the template; then, if the degree of matching is higher than a predetermined value, the face detection unit 21 may determine that the face candidate region is the face region.

When the face region has been detected successfully, the face detection unit 21 generates face region information representing the position and range of the face region. For example, the face region information may be generated as a binary image that has the same size as the image and in which the pixel values are different between the pixels contained in the face region and the pixels outside the face region. Alternatively, the face region information may include the coordinates of each corner of the polygon circumscribed about the face region.

The face detection unit 21 passes the face region information to the eye peripheral region detection unit 22.

The eye peripheral region detection unit 22 detects, from within the face region defined on the wide-angle image, an eye peripheral region containing the user's eyes and their peripheral region.

The narrow-angle image generated by the infrared camera 5 with a narrow angle of view may not contain the whole face and may, in some cases, contain only one of the eyes. In such cases, since information concerning other portions of the face such as the contour of the face cannot be used to identify the eye position, there has been the possibility that the eye position may not be detected correctly or, instead of the eye not contained in the image, some other portion of the face that has a feature similar to the eye may be erroneously detected as the eye. This has led to the problem that the pupil and the Purkinje image may not be able to be detected correctly. In view of this, according to the present embodiment, the control unit 9 detects the eye peripheral region from within the face region defined on the wide-angle image containing the whole face, and uses the eye peripheral region to restrict the region within which the eye is searched for in the narrow-angle image.

The brightness of the pixels corresponding to the eye greatly differs from the brightness of the pixels corresponding to the peripheral region of the eye. In view of this, the eye peripheral region detection unit 22 calculates differences between vertically adjacent pixels in the face region by applying, for example, Sobel filtering, and detects edge pixels between which the brightness changes in the vertical direction. Then, the eye peripheral region detection unit 22 detects, for example, a region bounded by two edge lines each formed by connecting a predetermined number of edge pixels corresponding to the size of the eye in a substantially horizontal direction, and takes such a region as an eye peripheral region candidate.

The two eyes of a human are arranged spaced apart from the other in the horizontal direction. In view of this, the eye peripheral region detection unit 22 extracts, from among the detected eye peripheral region candidates, two eye peripheral region candidates whose centers are the least separated from each other in the vertical direction but are separated from each other in the horizontal direction by a distance corresponding to the distance between the left and right eyes. Then, the eye peripheral region detection unit 22 determines that the region enclosed by the polygon circumscribed about the two eye peripheral region candidates is the eye peripheral region.

Alternatively, by performing template matching between the face region and a template corresponding to the two eyes, the eye peripheral region detection unit 22 may detect the region within the face region that best matches the template, and may determine that the detected region is the eye peripheral region. The eye peripheral region detection unit 22 passes eye peripheral region information representing the position and range of the eye peripheral region on the wide-angle image to the coordinate conversion unit 23. The eye peripheral region information includes, for example, the coordinates representing the position of each corner of the eye peripheral region on the wide-angle image.

The coordinate conversion unit 23 converts the position coordinates of the eye peripheral region detected on the wide-angle image, for example, the position coordinates of the respective corners of the eye peripheral region, into the position coordinates on the narrow-angle image by considering the angles of view of the wide-angle camera 3 and infrared camera 5 as well as their pixel counts, mounting positions, and shooting directions. In this way, the coordinate conversion unit 23 identifies the region on the narrow-angle image that corresponds to the eye peripheral region. For convenience, the region on the narrow-angle image that corresponds to the eye peripheral region will hereinafter be referred to as the enlarged eye peripheral region. The enlarged eye peripheral region is one example of the first region.

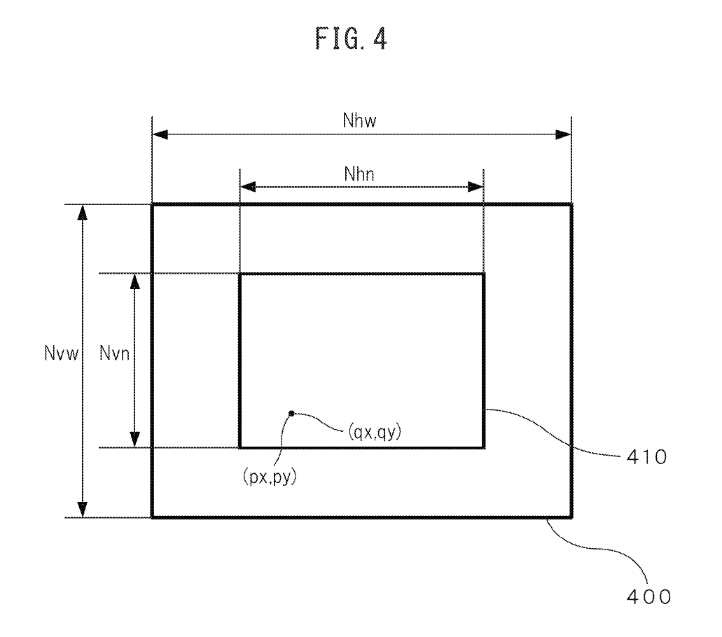

FIG. 4 is a diagram illustrating the relationship of the field of view of the wide-angle camera 3 relative to the field of view of the infrared camera 5 when observed from a position located a prescribed distance away from the display screen 2a of the display unit 2. In the illustrated example, it is assumed that the horizontal position of the wide-angle camera 3 is the same as that of the infrared camera 5, and that the optical axis of the wide-angle camera 3 and the optical axis of the infrared camera 5 cross each other at the position located the prescribed distance away from the display screen 2a. As a result, the center of the field of view 400 of the wide-angle camera 3 coincides with the center of the field of view 410 of the infrared camera 5. Let the horizontal pixel count of the wide-angle camera 3 be denoted by Nhw, and the vertical pixel count of the wide-angle camera 3 by Nvw. On the other hand, the horizontal pixel count of the infrared camera 5 is denoted by Nhn, and the vertical pixel count of the infrared camera 5 by Nvn. Further, the horizontal and vertical angles of view of the wide-angle camera 3 are denoted by ωhw and ωvw, respectively, and the horizontal and vertical angles of view of the infrared camera 5 are denoted by ωhn and ωvn, respectively. Then, the coordinates (qx, qy) of a given pixel in the narrow-angle image, with the origin taken at the center of the narrow-angle image, that correspond to the coordinates (px, py) of the corresponding pixel in the wide-angle image, are expressed by the following equations.

qx=(ωhw/ωhn)(Nhn/Nhw)px

qy=(ωvw/ωwn)(Nvn/Nvw)py (1)

The coordinate conversion unit 23 can identify the enlarged eye peripheral region by converting the position coordinates of the respective corners of the eye peripheral region on the wide-angle image into the corresponding position coordinates on the narrow-angle image, for example, in accordance with the above equations (1). If the optical axis of the wide-angle camera 3 is displaced from the optical axis of the infrared camera 5 by a given distance at the position of the user's face, the coordinate conversion unit 23 can obtain the coordinates (qx, qy) by merely adding an offset corresponding to that given distance to the right-hand sides of the equations (1).

According to one modified example, a coordinate conversion table for translating position coordinates on the wide-angle image into position coordinates on the narrow-angle image may be constructed in advance and may be stored in the storage unit 8. In this case, the coordinate conversion unit 23 can translate the position coordinates of the respective corners of the eye peripheral region on the wide-angle image into the corresponding position coordinates on the narrow-angle image by referring to the coordinate conversion table.

According to this modified example, the coordinate conversion unit 23 can accurately identify the enlarged eye peripheral region on the narrow-angle image that corresponds to the eye peripheral region on the wide-angle image, even when the distortion of the wide-angle camera 3 and the distortion of the infrared camera 5 are appreciably large.

According to another modified example, the coordinate conversion unit 23 may perform template matching between the narrow-angle image and a template corresponding to the eye peripheral region on the wide-angle image, and may detect the region that best matches the template as the enlarged eye peripheral region.

The coordinate conversion unit 23 passes enlarged eye peripheral region information representing the position and range of the enlarged eye peripheral region to the Purkinje image detection unit 24. The enlarged eye peripheral region information includes, for example, the position coordinates of the respective corners of the enlarged eye peripheral region defined on the narrow-angle image.

During the execution of the gaze detection process, the Purkinje image detection unit 24 detects the pupil and the Purkinje image from within the enlarged eye peripheral region defined on the narrow-angle image.

In the present embodiment, the Purkinje image detection unit 24 performs template matching between the enlarged eye peripheral region and a template corresponding to the pupil of one eye, and detects from within the enlarged eye peripheral region the region that best matches the template. Then, when the maximum value of the degree of matching is higher than a predetermined degree-of-matching threshold value, the Purkinje image detection unit 24 determines that the pupil is contained in the detected region. A plurality of templates may be prepared according to the size of the pupil. In this case, the Purkinje image detection unit 24 matches the enlarged eye peripheral region against the plurality of templates, and obtains the maximum value of the degree of matching. If the maximum value of the degree of matching is higher than the degree-of-matching threshold value, the Purkinje image detection unit 24 determines that the pupil is contained in the region that matches the template that yielded the maximum value of the degree of matching. The degree of matching is calculated, for example, as the value of normalized cross-correlation between the template and the region that matches the template. The degree-of-matching threshold value is set, for example, to 0.7 or 0.8.

The brightness of the region containing the pupil is lower than the brightness of its surrounding region, and the pupil is substantially circular in shape. In view of this, the Purkinje image detection unit 24 sets two concentric rings with differing radii within the enlarged eye peripheral region. Then, if the difference between the average brightness value of the pixels corresponding to the outer ring and the average brightness value of the inner pixels is larger than a predetermined threshold value, the Purkinje image detection unit 24 may determine that the region enclosed by the inner ring represents the pupil region. The Purkinje image detection unit 24 may detect the pupil region by further detecting whether the average brightness value of the region enclosed by the inner ring is not larger than a predetermined threshold value. In this case, the predetermined threshold value is set equal to a value obtained by adding 10 to 20% of the difference between the maximum and minimum brightness values of the enlarged eye peripheral region to the minimum brightness value.

When the pupil region has been successfully detected, the Purkinje image detection unit 24 calculates the position coordinates of the center of the pupil region by calculating the average values of the horizontal coordinate values and vertical coordinate values of the pixels contained in the pupil region. On the other hand, if the detection of the pupil region has failed, the Purkinje image detection unit 24 returns a signal representing the detection result to the control unit 9.

Further, the Purkinje image detection unit 24 detects the Purkinje image of the illuminating light source 4 from within the enlarged eye peripheral region. The brightness of the region containing the Purkinje image of the illuminating light source 4 is higher than the brightness of its surrounding region, and the brightness value is substantially saturated (i.e., the brightness value is substantially equal to the highest brightness value that the pixel value can take). Further, the shape of the region containing the Purkinje image of the illuminating light source 4 is substantially identical with the shape of the light-emitting face of the light source. In view of this, the Purkinje image detection unit 24 sets, within the enlarged eye peripheral region, two rings having a common center but differing in size and having a shape that substantially matches the contour shape of the light-emitting face of the illuminating light source 4. Then, the Purkinje image detection unit 24 obtains a difference value by subtracting the average brightness value of the outer pixels from the inner average brightness value representing the average brightness value of the pixels corresponding to the inner ring. Then, if the difference value is larger than a predetermined difference threshold value, and if the inner average brightness value is higher than a predetermined brightness threshold value, the Purkinje image detection unit 24 determines that the region enclosed by the inner ring represents the Purkinje image of the illuminating light source 4. The difference threshold value may be determined, for example, by taking the average value of the difference values calculated between adjacent pixels in the enlarged eye peripheral region. The predetermined brightness threshold value may be set, for example, to 80% of the highest brightness value in the enlarged eye peripheral region.

The Purkinje image detection unit 24 may detect the region containing the pupil by using any one of various other methods for detecting the region containing the pupil on the image. Likewise, the Purkinje image detection unit 24 may detect the region containing the Purkinje image of the light source by using any one of various other methods for detecting the region containing the Purkinje image of the light source on the image.

When the Purkinje image of the illuminating light source 4 has been detected successfully, the Purkinje image detection unit 24 calculates the position coordinates of the center of the Purkinje image by calculating the average values of the horizontal coordinate values and vertical coordinate values of the pixels contained in the Purkinje image. On the other hand, if the detection of the Purkinje image of the illuminating light source 4 has failed, the Purkinje image detection unit 24 returns a signal representing the detection result to the control unit 9. The Purkinje image detection unit 24 passes information indicating the center of the Purkinje image and the center of the pupil to the gaze detection unit 25.

During the execution of the gaze detection process, the gaze detection unit 25 detects the user's gaze direction or gaze position based on the center of the Purkinje image and the center of the pupil.

Since the surface of the cornea is substantially spherical in shape, the position of the Purkinje image of the light source remains substantially unchanged and unaffected by the gaze direction. On the other hand, the center of the pupil moves as the gaze direction moves. Therefore, the gaze detection unit 25 can detect the user's gaze direction by obtaining the position of the center of the pupil relative to the center of the Purkinje image.

In the present embodiment, the gaze detection unit 25 obtains the position of the center of the pupil relative to the center of the Purkinje image of the light source, for example, by subtracting the horizontal and vertical coordinates of the center of the Purkinje image from the horizontal and vertical coordinates of the center of the pupil. Then, the gaze detection unit 25 determines the user's gaze direction by referring to a mapping table that provides a mapping between the relative position of the center of the pupil and the user's gaze direction.

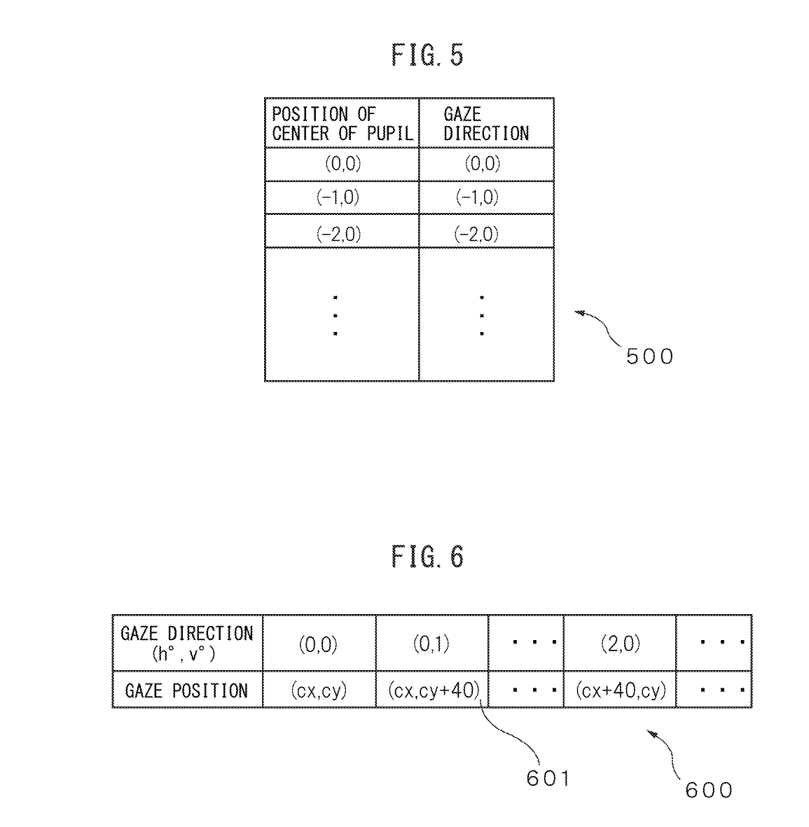

FIG. 5 is a diagram illustrating one example of the mapping table. Each entry in the left-hand column of the mapping table 500 carries the coordinates of the position of the center of the pupil relative to the center of the Purkinje image of the light source. Each entry in the right-hand column of the mapping table 500 carries the user's gaze direction corresponding to the coordinates of the relative position of the center of the pupil carried in the left-hand entry. In the illustrated example, the gaze direction is expressed in terms of the horizontal and vertical angular differences relative to the reference gaze direction which is, in this case, the gaze direction when the user is gazing at a designated reference point (for example, the center of the display screen 2a or the mounting position of the infrared camera 5). The coordinates of the relative position of the center of the pupil are expressed in units of pixels on the image.

Further, based on the user's gaze direction, the gaze detection unit 25 detects the position at which the user is gazing on the display screen 2a of the display unit 2. For convenience, the position on the display screen 2a at which the user is gazing will hereinafter be referred to simply as the gaze position. In the present embodiment, the gaze detection unit 25 determines the user's gaze position by referring to a gaze position table that provides a mapping between the user's gaze direction and the user's gaze position on the display screen.

FIG. 6 is a diagram illustrating one example of the gaze position table. The top row in the gaze position table 600 carries the user's gaze direction. Each entry in the gaze position table 600 carries the coordinates of the corresponding gaze position on the display screen in units of pixels. For example, entry 601 in the gaze position table 600 indicates that the gaze position is (cx, cy+40) when the gaze direction is 0° in the horizontal direction and 1° in the vertical direction. In the illustrated example, cx and cy are the coordinates of the gaze position when the gaze direction is (0, 0), i.e., the coordinates of the reference gaze position, for example, the horizontal and vertical coordinates of the center of the display screen 2a. The gaze detection unit 25 passes information indicating the user's gaze position to the application program being executed by the control unit 9.

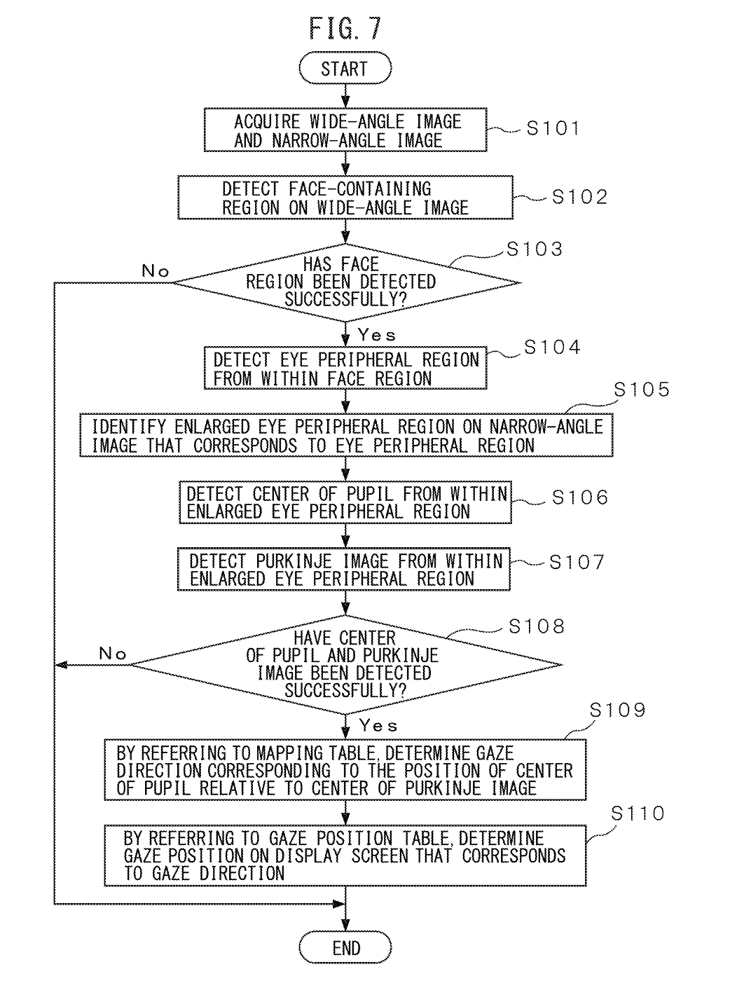

FIG. 7 is an operation flowchart of the gaze detection process carried out by the control unit 9. The control unit 9 carries out the gaze detection process in accordance with the following operation flowchart each time the wide-angle image and narrow-angle image are generated.

The control unit 9 acquires the wide-angle image from the wide-angle camera 3 and acquires the narrow-angle image generated by the infrared camera 5 by capturing an image of the user's face with the illuminating light source 4 turned on (step S101). The face detection unit 21 in the control unit 9 detects the face region containing the face on the wide-angle image (step S102). The face detection unit 21 determines whether the face region has been detected successfully or not (step S103). If the detection of the face region has failed (No in step S103), it is presumed that the user is not looking at the display screen 2a of the display unit 2. Therefore, the control unit 9 terminates the gaze detection process.

On the other hand, when the face region has been successfully detected (Yes in step S103), the face detection unit 21 passes the face region information to the eye peripheral region detection unit 22 in the control unit 9. The eye peripheral region detection unit 22 detects the eye peripheral region from within the face region detected on the wide-angle image (step S104). Then, the eye peripheral region detection unit 22 passes the eye peripheral region information to the coordinate conversion unit 23 in the control unit 9.

The coordinate conversion unit 23 identifies the enlarged eye peripheral region on the narrow-angle image that corresponds to the eye peripheral region detected on the wide-angle image (step S105). Then, the coordinate conversion unit 23 passes the enlarged eye peripheral region information to the Purkinje image detection unit 24 in the control unit 9.

The Purkinje image detection unit 24 detects the center of the pupil from within the enlarged eye peripheral region defined on the narrow-angle image (step S106). The Purkinje image detection unit 24 further detects the Purkinje image of the illuminating light source 4 from within the enlarged eye peripheral region (step S107). Then, the Purkinje image detection unit 24 determines whether the center of the pupil and the Purkinje image have been detected successfully (step S108).

If the Purkinje image detection unit 24 has failed to detect the center of the pupil or the Purkinje image of the illuminating light source 4 (No in step S108), the control unit 9 terminates the gaze detection process. After that, the control unit 9 may transmit control signals indicating new exposure conditions to the wide-angle camera 3 and the infrared camera 5 so that the user's face may be shot under the new exposure conditions different from the exposure conditions used for the previous shooting.

If the Purkinje image detection unit 24 has successfully detected the center of the pupil and the Purkinje image of the illuminating light source 4 (Yes in step S108), the Purkinje image detection unit 24 passes information indicating the center of the Purkinje image and the center of the pupil to the gaze detection unit 25.

The gaze detection unit 25 detects, by referring to the mapping table, the gaze direction corresponding to the position of the center of the pupil relative to the center of the Purkinje image (step S109).

The gaze detection unit 25 obtains, by referring to the gaze position table, the gaze position on the display screen 2a of the display unit 2 that corresponds to the gaze direction (step S110). Then, the gaze detection unit 25 passes information representing the gaze position to the application program being executed by the control unit 9. After that, the control unit 9 terminates the gaze detection process. The order of the steps S106 and S107 to be carried out by the Purkinje image detection unit 24 may be interchanged.

As has been described above, since the gaze detection apparatus according to the first embodiment detects the face region on the wide-angle image containing the whole face of the user, and then detects the eye peripheral region from within the face region, the detection accuracy of the eye peripheral region can be enhanced. Then, the gaze detection apparatus restricts the search range within which to detect the Purkinje image and the pupil on the narrow-angle image to the enlarged eye peripheral region corresponding to the eye peripheral region detected on the wide-angle image. As a result, if the whole face of the user is not contained in the narrow-angle image, the gaze detection apparatus can prevent the detection accuracy of the pupil and the Purkinje image from degrading. Furthermore, since the gaze detection apparatus can detect the pupil and the Purkinje image without having to adjust the orientation of the infrared camera, not only can the time taken to detect the user's gaze direction be shortened but the configuration of the apparatus can also be simplified.

Next, a gaze detection apparatus according to a second embodiment will be described. The gaze detection apparatus according to the second embodiment detects the position of the eye on the narrow-angle image with a higher degree of accuracy by redetecting the eye-containing region from within the region including and surrounding the enlarged eye peripheral region on the narrow-angle image that corresponds to the eye peripheral region detected from the wide-angle image. Then, the gaze detection apparatus detects the pupil and the Purkinje image from within the redetected eye-containing region, thereby reducing the chance of erroneously detecting some other part located outside the eye, for example, a mole, as being the pupil or the like.

The gaze detection apparatus according to the second embodiment differs from the gaze detection apparatus according to the first embodiment in the processing performed by the control unit. The following description therefore deals only with the control unit. For the other units constituting the gaze detection apparatus, refer to the related description in the first embodiment.

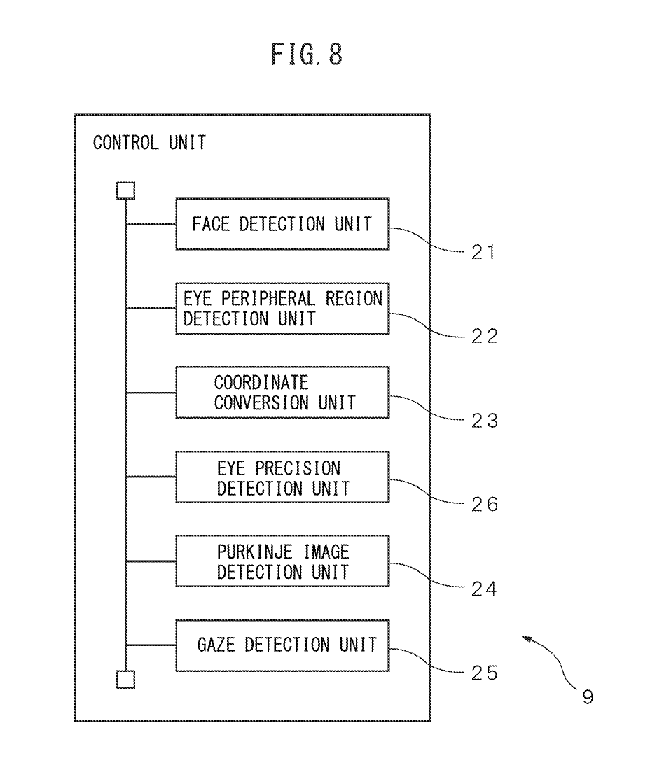

FIG. 8 is a functional block diagram of the control unit for implementing the gaze detection process in the gaze detection apparatus according to the second embodiment. The control unit 9 includes a face detection unit 21, an eye peripheral region detection unit 22, a coordinate conversion unit 23, an eye precision detection unit 26, a Purkinje image detection unit 24, and a gaze detection unit 25. These units constituting the control unit 9 are functional modules each implemented by executing a computer program on the processor incorporated in the control unit 9. Alternatively, these units constituting the control unit 9 may be implemented on a single integrated circuit on which the circuits corresponding to the respective units are integrated, and may be mounted in the computer 1 separately from the processor incorporated in the control unit 9.

In FIG. 8, the component elements of the control unit 9 are designated by the same reference numerals as those used to designate the corresponding component elements of the control unit in the gaze detection apparatus according to the first embodiment depicted in FIG. 3. The control unit 9 in the gaze detection apparatus according to the second embodiment differs from the control unit in the gaze detection apparatus according to the first embodiment by the inclusion of the eye precision detection unit 26. Therefore, the following describes the eye precision detection unit 26 and its associated parts.

The eye precision detection unit 26 receives the enlarged eye peripheral region information from the coordinate conversion unit 23. Then, the eye precision detection unit 26 redetects the eye-containing region from within the region including and surrounding the enlarged eye peripheral region on the narrow-angle image. For convenience, the eye-containing region detected by the eye precision detection unit 26 will hereinafter be referred to as the precision eye region.

Since the size of the user's eye contained in the narrow-angle image is larger than the size of the user's eye contained in the wide-angle image, the eye precision detection unit 26 can identify the position of the eye more accurately than the eye peripheral region detection unit 22 by using detailed information about the eye and its surrounding region.

In a manner similar to that the eye peripheral region detection unit 22 detects the eye peripheral region, the eye precision detection unit 26 performs template matching, for example, between the enlarged eye peripheral region detected on the narrow-angle image and a template corresponding to the two eyes. Then, the eye precision detection unit 26 can detect the region within the enlarged eye peripheral region that best matches the template as the precision eye region.

However, since the field of view of the infrared camera 5 is narrower than the field of view of the wide-angle camera 3, the whole face of the user may not be contained in the narrow-angle image. In this case, if the eye precision detection unit 26 uses the template corresponding to the two eyes, the detection accuracy of the precision eye region may drop because, in the enlarged eye peripheral region, only one eye matches the template. To address this, the eye precision detection unit 26 may change the template to be used, depending on whether or not the whole of the enlarged eye peripheral region is contained in the narrow-angle image.

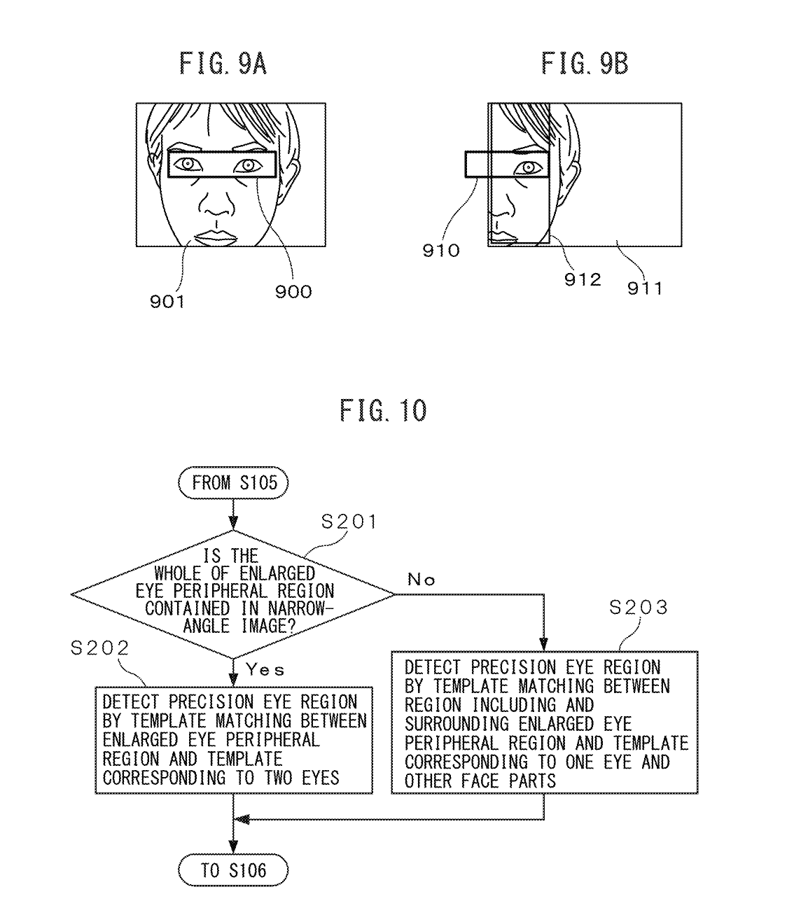

FIG. 9A is a diagram illustrating one example of the relative position of the enlarged eye peripheral region with respect to the narrow-angle image, and FIG. 9B is a diagram illustrating another example of the relative position of the enlarged eye peripheral region with respect to the narrow-angle image.

In the example illustrated in FIG. 9A, the whole of the enlarged eye peripheral region 900 is contained in the narrow-angle image 901. In this case, the eye precision detection unit 26 can use a template corresponding to the two eyes in order, for example, to detect the precision eye region. On the other hand, in the example illustrated in FIG. 9B, a portion of the enlarged eye peripheral region 910 lies outside the narrow-angle image 911. In this case, the eye precision detection unit 26 may use a template corresponding to the eye contained in the narrow-angle image and the user's other face parts (such as a nostril, mouth, eyebrow, etc.) than the eye. Further, in this case, since the face parts other than the eye are spaced away from the eye, the other parts may not be contained in the enlarged eye peripheral region. Therefore, as illustrated in FIG. 9B, a search range 912 for the precision eye region may be set by including not only the enlarged eye peripheral region but also its surrounding region that may potentially contain other parts included in the template.

Further, since the wide-angle camera 3 and the infrared camera 5 are mounted spaced apart from each other in the vertical direction of the display screen 2a, vertical parallax exists between the field of view of the wide-angle camera 3 and the field of view of the infrared camera 5. The parallax varies according to the distance from the display unit 2 to the user's face. In view of this, the eye precision detection unit 26 may not restrict the vertical search range for the precision eye region to the portion between the upper and lower edges of the enlarged eye peripheral region but may only restrict the horizontal search range to the portion between the left and right edges of the enlarged eye peripheral region.

From within the region that best matches the template within the search range defined in the region including and surrounding the enlarged eye peripheral region on the narrow-angle image, the eye precision detection unit 26 detects the portion corresponding to one or the other eye in the template and takes the detected portion as the precision eye region. Then, the eye precision detection unit 26 passes precision eye region information representing the position and range of the precision eye region to the Purkinje image detection unit 24. The Purkinje image detection unit 24 then detects the user's pupil and the Purkinje image of the illuminating light source 4 from within the precision eye region.

FIG. 10 is an operation flowchart illustrating the steps relating to the operation of the eye precision detection unit 26 in the gaze detection process carried out by the gaze detection apparatus according to the second embodiment. The steps depicted in FIG. 10 are carried out, for example, between the steps S105 and S106 of the gaze detection process depicted in FIG. 7.

When the enlarged eye peripheral region information is received from the coordinate conversion unit 23, the eye precision detection unit 26 determines whether the whole of the enlarged eye peripheral region is contained in the narrow-angle image (step S201). For example, if the coordinates of all the corners of the enlarged eye peripheral region in the coordinate system of the narrow-angle image are contained in the narrow-angle image, the eye precision detection unit 26 determines that the whole of the enlarged eye peripheral region is contained in the narrow-angle image. On the other hand, if the position coordinates of any one of the corners of the enlarged eye peripheral region lie outside the narrow-angle image, the eye precision detection unit 26 determines that a portion of the enlarged eye peripheral region is not contained in the narrow-angle image.

If the whole of the enlarged eye peripheral region is contained in the narrow-angle image (Yes in step S201), the eye precision detection unit 26 reads out the template corresponding to the two eyes from the storage unit 8. Then, the eye precision detection unit 26 detects the precision eye region by performing template matching between the readout template and the enlarged eye peripheral region (step S202). On the other hand, if a portion of the enlarged eye peripheral region lies outside the narrow-angle image (No in step S201), the eye precision detection unit 26 reads out a template corresponding to the eye contained in the narrow-image and other face parts from the storage unit 8. If the left-hand side of the enlarged eye peripheral region lies outside the narrow-angle image, there is the possibility that the right eye of the user is not contained in the narrow-angle image. In this case, the eye precision detection unit 26 uses a template corresponding to the user's left eye and other face parts. Conversely, if the right-hand side of the enlarged eye peripheral region lies outside the narrow-angle image, the eye precision detection unit 26 uses a template corresponding to the user's right eye and other face parts. Then, the eye precision detection unit 26 detects the precision eye region by performing template matching between the readout template and the region including and surrounding the enlarged eye peripheral region (step S203).

After step S202 or S203, the eye precision detection unit 26 passes the precision eye region information to the Purkinje image detection unit 24. The control unit 9 then proceeds to step S106 to perform the remaining process depicted in FIG. 7.

As has been described above, the gaze detection apparatus according to the second embodiment redetects the eye-containing region from within the region including and surrounding the enlarged eye peripheral region on the narrow-angle image corresponding to the eye peripheral region detected from the wide-angle image. Since this serves to reduce the chance of erroneously detecting some other face part as being the eye, the detection accuracy of the Purkinje image and the pupil can be further enhanced. As a result, the gaze detection apparatus can further enhance the detection accuracy of the user's gaze direction and gaze position.

According to one modified example of the second embodiment, the gaze detection unit 25 may estimate the distance from the display unit 2 to the user's face, based on the eye peripheral region detected from the wide-angle image and the precision eye region detected from the narrow-angle image.

Generally, the coordinates of each pixel in an image correspond to the direction pointing from the camera that captured the image to the object that contains that pixel. On the other hand, the distance between the wide-angle camera 3 and the infrared camera 5 and the directions of the optical axes of the respective cameras are known in advance. In view of this, the gaze detection unit 25 obtains, for example, from the position of one or the other eye in the eye peripheral region on the wide-angle image, a direction vector pointing from the wide-angle camera 3 to that eye. Likewise, from the position of that eye in the precision eye region on the narrow-angle image, the gaze detection unit 25 obtains a direction vector pointing from the infrared camera 5 to that eye. Then, based on the distance between the wide-angle camera 3 and the infrared camera 5 and on the direction vectors pointing from the respective cameras to the user's eye, the gaze detection unit 25 obtains the location of a point where the respective direction vectors intersect by using the technique of triangulation. The gaze detection unit 25 estimates the distance from the display unit 2 to the user's face by calculating the distance from the center of the display screen 2a of the display unit 2 to the point of intersection.

In the modified example, the gaze detection unit 25 can use the estimated distance from the display unit 2 to the user's face in order to obtain the user's gaze position on the display screen 2a with higher accuracy. For example, a gaze position table that provides a mapping between the gaze direction and the gaze position for each distance from the display unit 2 to the user's face may be stored in advance in the storage unit 8. In this case, the gaze detection unit 25 determines the gaze position by referring to the gaze position table read out of the storage unit 8 for the estimated distance from the display unit 2 to the user's face.

On the other hand, when only the gaze position table for a preassumed distance from the display unit 2 to the user's face (hereinafter called the reference distance) is stored in the storage unit 8, the gaze detection unit 25 obtains the ratio of the estimated distance from the display unit 2 to the user's face relative to the reference distance. Then, the gaze detection unit 25 may correct the gaze position by calculating the difference between the coordinates of the gaze position corresponding to the gaze direction obtained by referring to the gaze position table and the coordinates of the reference gaze position, and by moving the position away from the reference gaze position toward the gaze position by a distance obtained by multiplying the difference by that ratio. In this way, the gaze detection unit 25 can accurately detect the user's gaze position without relaying on the distance from the display unit 2 to the user's face.

Next, a gaze detection apparatus according to a third embodiment will be described. The gaze detection apparatus according to the third embodiment redetects the face region from within the region including and surrounding the region on the narrow-angle image corresponding to the face region detected from the wide-angle image, and detects the precision eye region from within the face region detected from the narrow-angle image.

The gaze detection apparatus according to the third embodiment differs from the gaze detection apparatus according to the first and second embodiments in the processing performed by the control unit. The following description therefore deals only with the control unit. For the other units constituting the gaze detection apparatus, refer to the related description in the first embodiment.

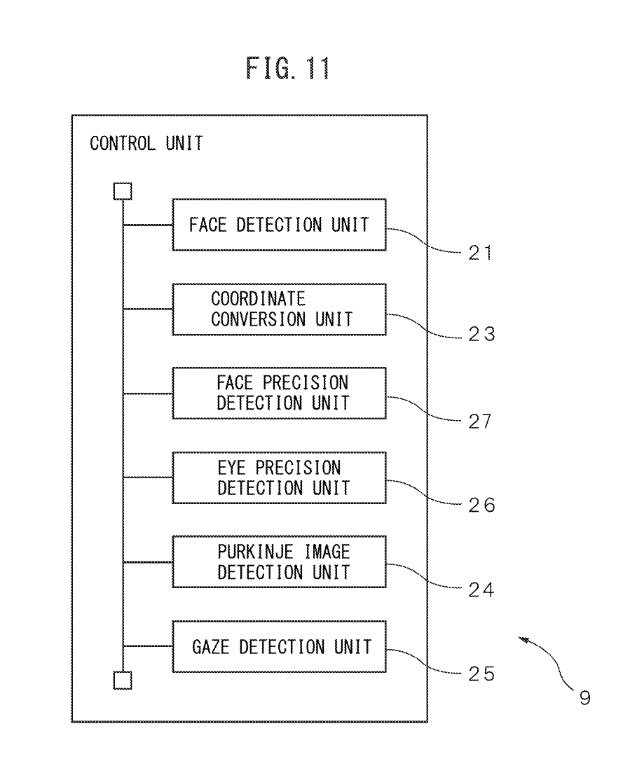

FIG. 11 is a functional block diagram of the control unit for implementing the gaze detection process in the gaze detection apparatus according to the third embodiment. The control unit 9 includes a face detection unit 21, a coordinate conversion unit 23, a face precision detection unit 27, an eye precision detection unit 26, a Purkinje image detection unit 24, and a gaze detection unit 25. These units constituting the control unit 9 are functional modules each implemented by executing a computer program on the processor incorporated in the control unit 9. Alternatively, these units constituting the control unit 9 may be implemented on a single integrated circuit on which the circuits corresponding to the respective units are integrated, and may be mounted in the computer 1 separately from the processor incorporated in the control unit 9.

In FIG. 11, the component elements of the control unit 9 are designated by the same reference numerals as those used to designate the corresponding component elements of the control unit in the gaze detection apparatus according to the second embodiment depicted in FIG. 8. The control unit 9 in the gaze detection apparatus according to the third embodiment differs from the control unit in the gaze detection apparatus according to the second embodiment in that the eye peripheral region detection unit 22 is replaced by the face precision detection unit 27. Therefore, the following describes the face precision detection unit 27 and its associated parts.

The face detection unit 11 passes the face region information to the coordinate conversion unit 23. The coordinate conversion unit 23 converts the position of each corner of the face region on the wide-angle image into the corresponding position on the narrow-angle image by using the earlier given equations (1) or by referring to the coordinate conversion table, and thereby identifies the region on the narrow-angle image (for convenience, hereinafter called the enlarged face region) corresponding to the face region on the wide-angle image. Then, the position detection unit 23 passes enlarged face region information representing the position and range of the enlarged face region to the face precision detection unit 27. The enlarged face region is another example of the first region.

The face precision detection unit 27 detects the region containing the user's face (for convenience, hereinafter called the precision face region) from within the region including and surrounding the enlarged face region on the narrow-angle image.

In the present embodiment, during shooting, the user's face is illuminated with the infrared light radiated from the illuminating light source 4; since the reflectivity of skin to infrared light is relatively high (for example, the reflectivity of skin is several tens percent in the near-infrared wavelength region), the brightness of the pixels representing the skin of the face in the narrow-angle image is high. On the other hand, in the narrow-angle image, the user's hair or the region behind the user has low reflectivity to infrared light or is located farther away from the illuminating light source 4; as a result, the brightness of the pixels representing the user's hair or the region behind the user is relatively low. Therefore, the face precision detection unit 27 compares the value of each pixel in the enlarged face region with a given threshold value. The given threshold value is set, for example, equal to the maximum brightness value of the enlarged face region multiplied by 0.5. The face precision detection unit 27 extracts any pixel whose brightness value is not smaller than the given threshold value as a face region candidate pixel that may potentially be contained in the face region.

When the face region candidate pixels are detected, the face precision detection unit 27 can detect the precision face region by performing processing on the face region candidate pixels in a manner similar to that the face detection unit 21 does.

The face precision detection unit 27 passes information representing the precision face region to the eye precision detection unit 26.

The eye precision detection unit 26, unlike the eye precision detection unit in the second embodiment, detects the precision eye region containing the user' eye from within the precision face region detected on the narrow-angle image. Then, the Purkinje image detection unit 24 detects the pupil and the Purkinje image from within the precision eye region.

If the precision face region lies in contact with the left edge of the narrow-angle image, there is the possibility that the right eye of the user is not contained in the narrow-angle image. In this case, the eye precision detection unit 26 may read out a template corresponding to the user's left eye and other face parts from the storage unit 8 and use it in order to detect the precision eye region. Conversely, if the precision eye region lies in contact with the right edge of the narrow-angle image, there is the possibility that the left eye of the user is not contained in the narrow-angle image. In this case, the eye precision detection unit 26 may read out a template corresponding to the user's right eye and other face parts from the storage unit 8 and use it in order to detect the precision eye region.

As earlier described, since the wide-angle camera 3 and the infrared camera 5 are mounted spaced apart from each other in the vertical direction of the display screen, vertical parallax exists between the field of view of the wide-angle camera 3 and the field of view of the infrared camera 5. In view of this, according to one modified example of the third embodiment, the face precision detection unit 27 may not restrict the vertical search range for the precision face region to the portion between the upper and lower edges of the enlarged face region but may only restrict the horizontal search range to the portion between the left and right edges of the enlarged face region.

The gaze detection process according to the third embodiment differs from the gaze detection process according to the first embodiment depicted in FIG. 7 by the omission of step S104. Instead, in the gaze detection process according to the third embodiment, in step S105 the control unit 9 identifies the enlarged face region corresponding to the face region. Then, after step S105 and before step S106, the control unit 9 detects the precision face region and precision eye region from within the search range that has been set based on the enlarged face region. In steps S106 and S107, the control unit 9 detects the center of the pupil and the Purkinje image, respectively, from within the enlarged eye peripheral region.

As has been described above, the gaze detection apparatus according to the third embodiment redetects the face-containing region from within the region including and surrounding the enlarged face region on the narrow-angle image corresponding to the face region detected from the wide-angle image. Since this serves to reduce the chance of erroneously detecting the face-containing region on the narrow-angle image, the detection accuracy of the Purkinje image and the pupil in the face-containing region can also be enhanced. As a result, the gaze detection apparatus can further enhance the detection accuracy of the user's gaze direction and gaze position.

According to another modified example of the third embodiment, the face precision detection unit 27 may be omitted, and the eye precision detection unit 26 may be configured to directly detect the precision eye region from within the enlarged face region. In this modified example also, since the template to be used for the detection of the precision eye region can be changed depending on whether the whole of the enlarged face region is contained in the narrow-angle image or not, the eye-containing region can be detected with a higher degree of accuracy than when directly detecting the eye-containing region from the narrow-angle image.

In the above embodiments and their modified examples, the control unit 9 may generate a reduced image by decimating the pixels at a predetermined rate for each of the wide-angle and narrow-angle images and may perform the above processing by using the reduced images. Since this serves to reduce the amount of data used for the gaze detection process, the control unit 9 can reduce the time needed to carry out the gaze detection process.

The gaze detection apparatus according to each of the above embodiments or their modified examples may be incorporated in an apparatus that operates by using the user's gaze direction, for example, a car driving assisting apparatus that determines whether to alert the user or not by detecting a change in the user's gaze direction. In this case, the gaze detection unit need only detect the user's gaze direction and may not detect the user's gaze position.

A computer program for implementing the various functions of the control unit in the gaze detection apparatus according to each of the above embodiments or their modified examples may be provided in the form recorded on a computer readable recording medium such as a magnetic recording medium or an optical recording medium. The recording medium here does not include a carrier wave.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of superiority and inferiority of the invention. Although the embodiments of the present invention have been described in detail, it should be understood that the various changes, substitutions, and alterations could be made hereto without departing from the spirit and scope of the invention.

What is claimed is:

1. A gaze detection apparatus comprising:
a light source which illuminates a user's eye;
a first imaging unit which has a first angle of view, and generates a first image by capturing an image of the user's face;
a second imaging unit which has a second angle of view narrower than the first angle of view, and generates a second image by capturing an image of at least a portion of the user's face;
a face detection unit which detects from the first image a face region containing the user's face;
a coordinate conversion unit which identifies on the second image a first region that corresponds to the face region or to an eye peripheral region detected from within the face region as containing the user's eye;
a Purkinje image detection unit which detects a corneal reflection image of the light source and the center of the user's pupil from within an eye region, identified based on the first region, that contains the user's eye on the second image; and
a gaze detection unit which detects the user's gaze direction or gaze position based on a positional relationship between the center of the pupil and the corneal reflection image.

2. The gaze detection apparatus according to claim 1, further comprising an eye peripheral region detection unit which detects the eye peripheral region from within the face region detected on the first image.

3. The gaze detection apparatus according to claim 2, wherein the first region is a region on the second image that corresponds to the eye peripheral region, and further comprising an eye precision detection unit which detects the eye region within a search range that is set on the second image in accordance with the first region.

4. The gaze detection apparatus according to claim 3, wherein when the whole of the first region is contained in the second image, the eye precision detection unit detects the eye region by using information corresponding to both eyes of the user, while, when a portion of the first region is not contained in the second image, the eye precision detection unit detects the eye region by using information corresponding to one or the other eye of the user and the user's face parts other than the eye.

5. The gaze detection apparatus according to claim 4, wherein when the whole of the first region is contained in the second image, the eye precision detection unit sets the first region as the search range, while, when a portion of the first region is not contained in the second image, the eye precision detection unit sets the search range by taking the first region and a region that is located around the first region and that potentially contains the user's face parts other than the eye.

6. The gaze detection apparatus according to claim 3, wherein the first imaging unit and the second imaging unit are arranged vertically spaced apart from each other, and the eye precision detection unit sets the search range in such a manner as to be bounded by left and right edges of the first region.

7. The gaze detection apparatus according to claim 1, wherein the first region is a region on the second image that corresponds to the face region, and further comprising an eye precision detection unit which detects the eye region within a second search range that is set on the second image in accordance with the first region.

8. The gaze detection apparatus according to claim 7, further comprising a face precision detection unit which detects a second face region containing the user's face, within the second search range that is set on the second image in accordance with the first region, and wherein the eye precision detection unit detects the eye region from within the second face region.

9. The gaze detection apparatus according to claim 8, wherein the first imaging unit and the second imaging unit are arranged vertically spaced apart from each other, and the face precision detection unit sets the second search range in such a manner as to be bounded by left and right edges of the first region.

10. The gaze detection apparatus according to claim 1, wherein the first imaging unit and the second imaging unit are disposed around a display screen of a display device, and wherein
the gaze detection unit detects the user's gaze position on the display screen, based on the positional relationship between the center of the pupil and the corneal reflection image.

11. The gaze detection apparatus according to claim 10, wherein the first imaging unit is disposed above the display screen, and the second imaging unit is disposed below the display screen.

12. The gaze detection apparatus according to claim 1, wherein the first imaging unit and the second imaging unit are disposed around a display screen of a display device, and wherein
the gaze detection unit estimates a distance from the display device to the user's face, based on the position of the user's eye in the first region on the first image and the position of the user's eye in the eye region on the second image and on the distance between the first imaging unit and the second imaging unit, and detects the user's gaze position on the display screen, based on the estimated distance and on the positional relationship between the center of the pupil and the corneal reflection image.

13. A gaze detection method comprising:
detecting a face region containing a user's face from a first image generated by a first imaging unit having a first angle of view by a processor;
identifying a first region on a second image generated by a second imaging unit having a second angle of view narrower than the first angle of view by the processor, wherein the first region corresponds to the face region or to an eye peripheral region detected from within the face region as containing the user's eye;
detecting a corneal reflection image of a light source illuminating the user's eye and the center of the user's pupil from within an eye region, identified based on the first region, that contains the user's eye on the second image by the processor; and
detecting the user's gaze direction or gaze position based on a positional relationship between the center of the pupil and the corneal reflection image by the processor.

14. A non-transitory computer-readable recording medium having recorded thereon a gaze detection computer program for causing a computer to execute:
detecting a face region containing a user's face from a first image generated by a first imaging unit having a first angle of view;
identifying a first region on a second image generated by a second imaging unit having a second angle of view narrower than the first angle of view, wherein the first region corresponds to the face region or to an eye peripheral region detected from within the face region as containing the user's eye;
detecting a corneal reflection image of a light source illuminating the user's eye and the center of the user's pupil from within an eye region, identified based on the first region, that contains the user's eye on the second image; and
detecting the user's gaze direction or gaze position based on a positional relationship between the center of the pupil and the corneal reflection image.
